(19) United States
(12) Patent Application Publication
(10) Pub. No.: US 2013/0289952 A1
(43) Pub. Date: Oct. 31, 2013

(54) Estimating Occupancy Of Buildings

(71) Applicants: Manish Marwah, Palo Alto, CA (US); Gowtham Bellala, Palo Alto, CA (US); Martin Arlitt, Calgary (CA); Cullen E. Bash, Los Gatos, CA (US); Chandrakant Patel, Fremont, CA (US)

(72) Inventors: Manish Marwah, Palo Alto, CA (US); Gowtham Bellala, Palo Alto, CA (US); Martin Arlitt, Calgary (CA); Cullen E. Bash, Los Gatos, CA (US); Chandrakant Patel, Fremont, CA (US)

(21) Appl. No.: 13/458,462

(22) Filed: Apr. 27, 2012

(51) Int. Cl. G06F 17/10

(52) U.S. Cl. 703/2

(57) ABSTRACT

A method of determining occupancy of a building using a hidden Markov model.

### BACKGROUND

Commercial buildings use a significant amount of energy as part of their day-to-day operations. It is estimated that commercial buildings in the United States alone consumed an estimated 37% of the total electricity generated in the United States. The electricity cost for a building operator or tenant of a building is one of the largest costs associated with the building. The two primary uses of electricity in commercial buildings are generally related to lighting and climate control or HVAC.

To reduce energy consumption, building managers employ a variety of methods and devices to estimate building occupancy, such as timers and motion detectors. To avoid turning off or reducing services while the building is occupied, timers are typically configured to reduce lighting and climate control well before or well after a building is considered occupied, which minimizes their effectiveness on a day to day basis. In addition, timers are incapable of adjusting for floating holidays or other periods of abnormally low building occupancy, unless specifically programmed by the operator. Motion detectors solve many of the issues associated with timers, but are very expensive to install throughout a building and interconnect with a controller, particularly in existing buildings

### BRIEF DESCRIPTION OF THE DRAWINGS

The detailed description will refer to the following Figures in which like numerals refer to like items, and in which:

FIG. 1 illustrates a system to estimate occupancy of buildings;

FIG. 2 illustrates an example of a block diagram of modules used in an unsupervised approach to estimate building occupancy;

FIG. 3 illustrates an example of a block diagram of modules used in a semi supervised approach to estimate building occupancy

FIG. 4 illustrates a flowchart showing a method of estimating occupancy using a hidden Markov model.

FIG. 5 illustrates a flowchart showing a method of estimating occupancy using a hidden Markov model in combination with a classification.

FIG. 6 illustrates a hidden Markov model used in estimating building occupancy, with hidden variable Xₜ and observed variable Zₜ.

FIG. 7 illustrates a hidden Markov model used in estimating building occupancy, with hidden variable Xₜ and observed variable Zₜ in combination with a classifier

FIG. 8 illustrates the average error rates of the different models, including (1) binary hidden Markov model; (2) a k-hidden Markov model used with a Naïve Bayes classifier; (3) a k-hidden Markov model used with an SVM classifier; and (4) network activity with a SVM classifier.

FIG. 9 illustrates occupancy over time, comparing actual occupancy with predicted occupancy.

FIG. 10 illustrates the lighting energy savings for various zones, comparing static scheduling with the dynamic scheduling.

### DETAILED DESCRIPTION

Methods of estimating occupancy are used to reduce power consumption of commercial buildings. An example of a method of estimating occupancy of a building uses existing communication networks throughout the building that are readily available in most office and commercial buildings. More specifically, port level network statistics that already exist may be monitored within the building to determine in-flowing and out-flowing network port statistics to estimate the occupancy state of individual work spaces. The activity status of individual network ports with the building is collected. This activity status is then used to estimate parameters of a hidden Markov model to determine occupancy statistics of individual workspaces or zones including a plurality of individual work spaces.

Building services, including lighting and HVAC, may then be controlled at the individual work space level or in zones including selected work spaces. The building occupancy may be estimated in an unsupervised approach using hidden Markov models to estimate occupancy from network statistics, such as an activity status of individual network ports. In some instances the method may further employ a semi-supervised approach, which incorporates some labeled data and the effect of external features, such as time of the day, day of the week, day of the month, day of the year, or any other desirable feature.

These principles are discussed herein with respect to example processes, methods, system, and apparatus, and with reference to various diagrams. The example embodiments are shown and described as a series of blocks, but are not limited by this depiction, as the actions, steps, concepts, and principles associated with the illustrated blocks may occur in different orders than as described, and/or concurrently, and fewer or more than the illustrated number of blocks may be used to implement an example method. Blocks may be combined or include multiple components or steps.

The functional units described herein as steps, methods, processes, systems, subsystems, routines, modules, and so forth, may be implemented by a processor executing software. Executable code may include physical and/or logical blocks of computer instructions that may be organized as a procedure, function, and so forth. The executables associated with an identified process or method need not be physically collocated, but may include disparate instructions stored in different locations which, when joined together, collectively perform the method and/or achieve the purpose thereof. Executable code may be a single instruction or many, may be distributed across several different code segments, among different programs, across several memory devices, and so forth. Methods may be implemented on a computer, with the term “computer” referring herein to one or more computers and/or a computer network, or otherwise in hardware, a combination of hardware and software, and so forth.

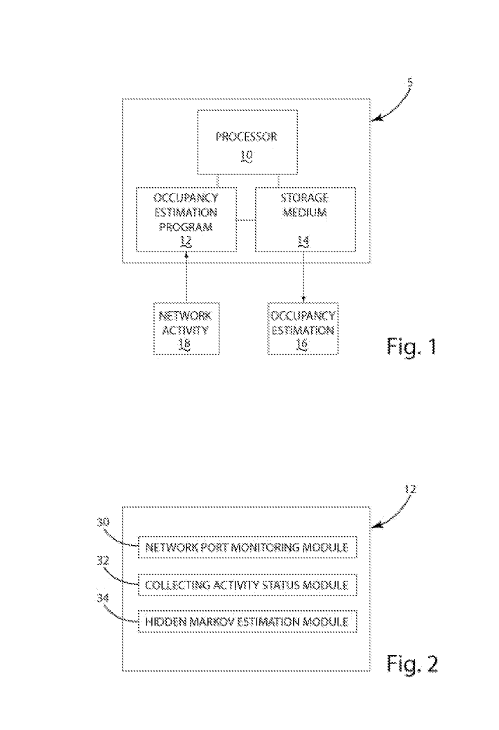

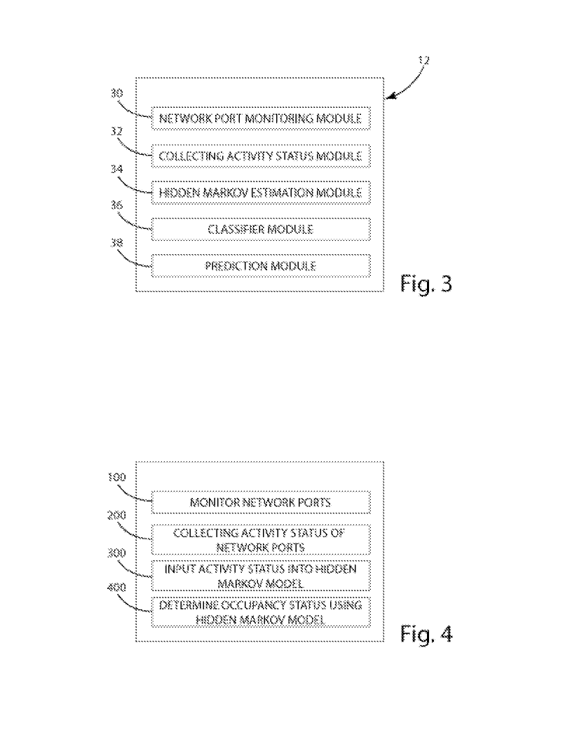

FIG. 1 illustrates a system 5 having a processor 10, an occupancy estimation program 12 and having instructions stored on a computer readable storage medium to estimate the occupancy of a building. The processor 10 is in communication with individual network switches containing network ports and receives network activity statistics 18 from the individual network ports to output an occupancy estimation 16. FIG. 2 illustrates a block diagram of the occupancy estimation program 12. As shown in FIG. 2, the occupancy estimation program 12 includes in the unsupervised approach a network port monitoring module 30, a collecting activity status module 32 and a hidden Markov estimation module 34. As further shown in FIG. 3, the occupancy estimation program further includes in a semi-supervised approach a classifier module 36 and a prediction module 38. The network port monitoring module 30 monitors an individual network port or a group of individual network ports for network activity statistics. The collecting activity status module 32 collects network status from an individual network port or group of network ports. The hidden Markov estimation module 34 takes the activity status from the collecting activity status module 32 and inputs it into a hidden Markov estimation module 34 and outputs an estimation of occupancy of individual work spaces or zones including multiple work spaces. As further detailed in FIG. 3, in the semi-supervised approach, the classifier module 36 allows additional inputs to further improve the accuracy of the occupancy estimation. These additional inputs are further described below. The classifier module 36 takes the output from the hidden Markov estimation module 34 and adds in the additional inputs and provides an output to a prediction module 38. The prediction module 38 estimates the occupancy of individual work spaces, groups of workspaces and zones. The occupancy estimation may be used in any desired control of building equipment and systems, such as lighting and HVAC systems.

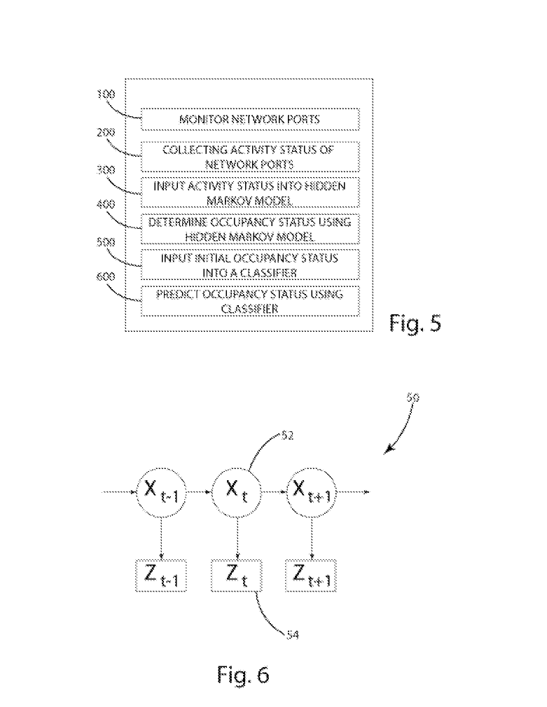

FIG. 4 is a flow chart of an unsupervised method of estimating building occupancy using a hidden Markov model. As illustrated in FIG. 4, the method includes a block 100 to monitor network ports 100, a block 200 to collect activity status of network ports, a block 300 to input the activity status from the collection block 200 into a hidden Markov model, and a block 400 to determine occupancy status using the hidden Markov model. The method illustrated in FIG. 4 illustrates an example of the unsupervised approach. As further illustrated in FIG. 5, the method illustrates a semi-supervised approach, the first four blocks 100, 200, 300 and 400, is similar. In the semi-supervised approach, the output from the fourth clock 400 provides an initial occupancy status using the hidden Markov model and in the fifth block 500, the initial occupancy status is input into the classifier. In the sixth block, the occupancy status is predicted using the classifier. Of course, the method may include additional blocks in both the unsupervised and semi-supervised approach.

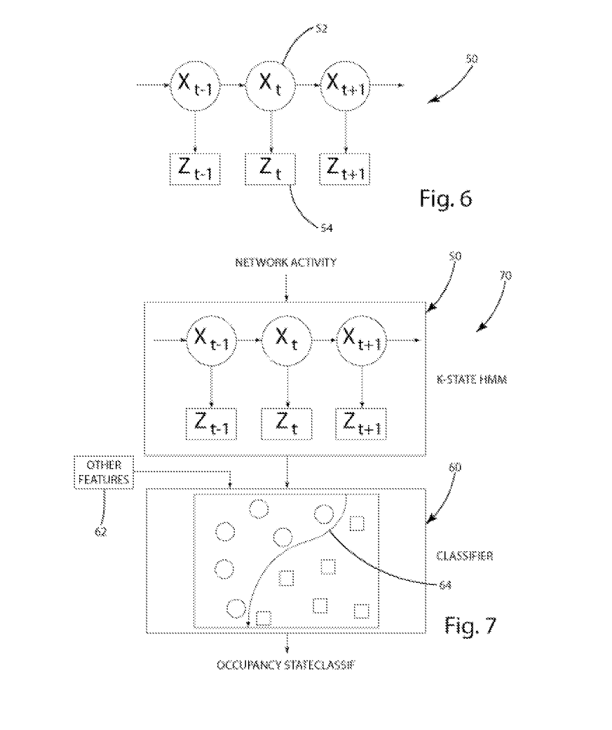

FIG. 6 illustrates the hidden Markov model 50 used to determine occupancy. The method illustrated in FIG. 6 is an unsupervised approach where the occupancy of a particular work space or zone is estimated using binary occupancy states. The method may monitor individual work spaces, such as individual cubicles or offices. The method may also monitor multiple work spaces that are clumped into individual zones. The unsupervised approach requires little to no human interaction as it considers activity or no activity as part of the network statistics.

Most office and commercial buildings have communication networks throughout the building. The method uses already available network statistics at the port level regarding in-flowing and out-flowing network port statistics to estimate the occupancy state of individual work spaces. For example, traffic data is available from network switches which typically maintain per port counters for the amount of traffic flowing in and out. The services, including lighting and climate, may then be controlled at the individual work space level or in zones including selected work spaces.

What qualifies as network activity may vary depending upon the type of building, and the type of activities performed by the occupants of the building. A building may have different activities in different areas, and while one area with low activity network statistics may be occupied, another area with higher network activity statistics may be unoccupied. In addition, while it is possible to consider the immediate network activity to determine if a work space is occupied or unoccupied, the method preferably measures network activity within a specified time period. For example, while a number of work spaces may be actually occupied, little to no network activity may be occurring, because the occupants are doing other activities not requiring network activity. More specifically, an occupant of a work space may be talking on the phone, reading printed material, or doing any other activity that would generate little to no network activity. Another consideration in determining network activity is that many computers and other electronic devices connected to a buildings networks may send small test packets or always have some network activity, even if the work space is actually unoccupied.

To avoid mischaracterizing a work space or zone or multiple work spaces as unoccupied or occupied, the method views the network activity over a desired time period. This desired time period may be set by the building operator based on a number of factors. If the time period is too long, the method may waste energy from the delay in changing the classification of the building from occupied to unoccupied. For example, in the late afternoon to early night, most office buildings slowly shift from being occupied to unoccupied as the workers leave. If the time period is set to two hours for determining the activity level from the network ports, the building lighting and HVAC may stay on long beyond the desired time for shutoff, or a reduction in building services as the last occupants may have left, and the building does not determine that it has reached a state where it would be consider to be not occupied until two hours later. Likewise, if the time period is too long, the method would be slow in recognizing that occupants have arrived and that the building should be considered as occupied. Similar issues may occur if the time period is too short, as the building may change its status between occupied and unoccupied too quickly, such that lighting may be turning off in individual work spaces while the occupant is otherwise engaged, and little to no network activity is currently occurring for a short period of time. While the time period for measuring network activity may vary depending on the type of building, type of work being performed, and other considerations, it has been found that a thirty minute time period provides a good balance for most office buildings.

In addition to the time period over which the activity is measured, the method may set a baseline activity level within that time period. For example, some electronic devices maintain a connection with other devices or the internet, and therefore they typically have some activity level, even when the work space is not occupied or the electronic device is not being used. The amount of activity produced by an unoccupied space within the desired time period may vary, and building operators may set a baseline level above which the work space is considered occupied and below which the work space in question is considered unoccupied. Therefore, in this example, for the building to have activity at the network port, the activity should reach a certain level before the building is considered occupied. Likewise, for the building to be considered unoccupied, the activity does not necessarily need to reach zero, but fall below a certain level.

It should be noted that for a particular building, the baseline level may be different for the method to determine that a change from unoccupied to occupied, or occupied to unoccupied, is needed. For example, a building may have a number of workers leaving the building near the same time, and when the workers arrive in the building, their arrival may be spread over a wider time period. It may be desirable to set the baseline higher for the occupied to unoccupied status transition than the unoccupied to occupied status transition.

If a building contains similar uses throughout the building, such as solely office space, it is likely that the same baseline activity level may be applied across multiple work spaces, or zones including work spaces. However, if the building contains different kinds of electronic devices or differing functions in different work spaces, such as office space in at least one work space or zone, and research labs in another work space or zone, the method may allow for different baseline activity levels for a given time period or a different zone or work space to be set.

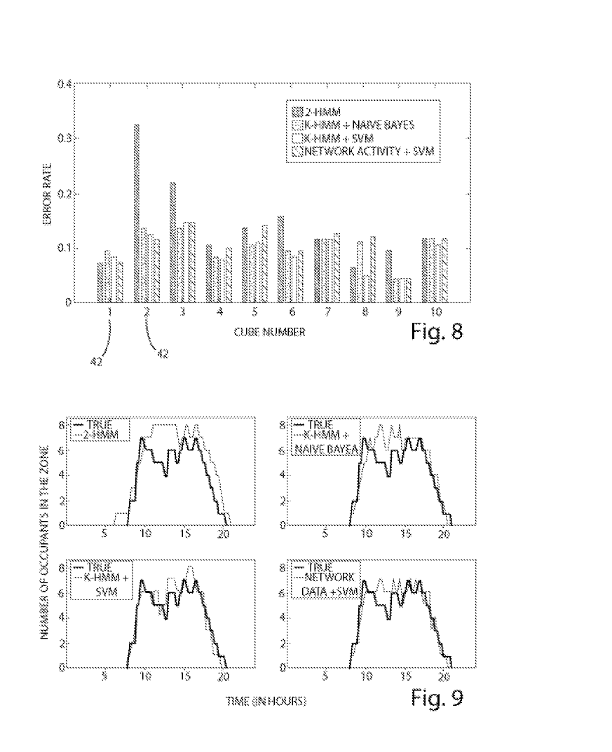

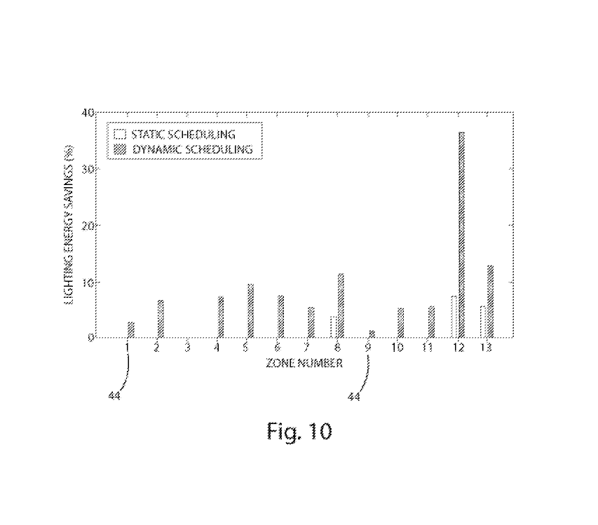

A building operator may divide the building into different work spaces 42 or zones 44 as desired. As illustrated in FIG. 8 and FIG. 10, the cube (or work spaces 42) and zones 44 may vary in occupancy and energy use. One example as a way to divide the building into zones 44 having multiple work spaces 42 is, if available, using WI-FI access nodes as the individual network ports on which activity over a specified time period is monitored. Of course, for existing buildings, the building may be able to remotely control lighting, HVAC, or other items by zones 44, and the building operator will need to determine what network ports generally are associated with the zones 44 for which control is available. For some buildings, the control of the HVAC may be split from the lighting of the building. For example, if the HVAC lumps together multiple work spaces 42 into a zone 44, while lighting control is available on the individual office level, the method may differentiate between these types of controls. More specifically, the method may determine that an individual work space 42 is unoccupied and turn off the lights, but also determine that the zone 44 for which HVAC control is available is occupied, even though a work space 42 within that zone 44 is unoccupied. Therefore, the method would leave the HVAC control status as occupied for the zone 44, but switch the control status of the work space 42 to unoccupied.

There are various challenges in modeling occupancy using network activity, one of the main challenges being the lack of labeled data. Obtaining labeled data from each occupant is not only expensive but also raises issues related to privacy. Using HMM allows the building operator to estimate occupancy from network statistics, while substantially eliminating or reducing any privacy concerns, as well as the expense of labeling the data. Therefore, if an HMM is used by itself, the building operator does not need to obtain labeled data.

A hidden Markov model (HMM) is a statistical Markov model in which the system being modeled is assumed to be a Markov process with unobserved (hidden) states. Using the HMM allows an unsupervised approach where the determination of occupancy of work spaces is solely modeled from port network statistics. Unlike a regular Markov model where the state transition probabilities are the unknown parameters, in a HMM, the state is not directly visible, but output, dependent on the state, is visible. Each state has a probability distribution over the possible output tokens, referred to as emission probabilities. The observed output tokens provide some information about the hidden states.

An HMM can be considered as the simplest dynamic Bayesian network. In a regular Markov model, the state is directly visible to the observer, and therefore the state transition probabilities are the parameters. In a hidden Markov model, the state (occupancy of the building) is not directly visible, but output, dependent on the state (activity levels of networks), is visible. Each state has a probability distribution over the possible output tokens. Therefore the sequence of tokens generated by an HMM gives some information about the sequence of states. Note that the adjective “hidden” refers to the state sequence through which the model passes, not to the parameters of the model; even if the model parameters are exactly known, the model is still “hidden”.

An HMM may have two phases in the current method: a learning phase where the state transition probabilities and the emission probabilities are estimated, and a decoding phase to estimate the hidden states from the observed tokens using the estimated probability parameters. As illustrated in FIG. 6, the occupancy estimation from network data as a HMM 50 is modeled, with binary occupancy states as the hidden variable X(t) 52 and network data as the observed variable Z(t), 54 as shown in FIG. 1. The model assumes that the transition probabilities and the emission probabilities do not vary with time or any other external parameters. The X(t+1) and X(t−1) show the next time period and the last time period.

A hidden Markov model can be considered a generalization of a mixture model where the hidden variables (or latent variables), which control the mixture component to be selected for each observation, are related through a Markov process rather than independent of each other. The HMM provides a foundation for making a probalistic model of a linear sequence problem. A building operator may have to experiment with the type of network statistics before setting a minimum activity threshold where the state of the building flips from occupied to unoccupied or unoccupied to occupied. In addition, the building operator may need to determine what network ports are associated with what zones or work spaces. The estimated occupancies at work space level can then be aggregated to estimate occupancy of a zone in a building. This can then be further used for occupancy-based lighting and HVAC scheduling of that zone. The actual observation of activity status may be performed through any known method, and most networks have the ability to show in real time the activity status on any given network port.

The method generally includes the steps of collecting port level network statistics. The method then uses an expectation maximization (EM) algorithm (e.g. Baum-Welsh) to learn the parameters (transition and emission probabilities) of the 2-state HMM model. Once the parameters are learned, given a sequence of Z(t)'s (network statistics), a decoding algorithm such as Viterbi is used to determine the best sequence of hidden states, X(t)'s (occupancy state).

While a semi supervised approach as described below typically improves occupancy modeling, as illustrated in FIG. 9, the unsupervised approach of the hidden Markov, very closely models the actual occupancy of various work spaces.

FIG. 7 illustrates a semi-supervised HMM approach 70. The method in FIG. 7 performs all the method steps described above and illustrated in FIG. 6, but also adds additional variables by combining the output of the HMM with standard classifiers, 60 such as naïve Bayes or support vector machines (SVM). This two step approach simplifies the occupancy model while achieving good accuracy. Using the two step semi-supervised approach, the method was able to predict for ten office cubicles, which are the work spaces, the occupied or unoccupied status with an error rate of less than 15% with an average error of 9.3%. More specifically, the experiment was carried out on three two story buildings, having an approximate total footprint of 300,000 sq. ft. and hosting about 500 occupants.

While the semi-supervised approach does require minimal labeled data, the extra steps to provide such data usually provide more accurate estimation of building occupancy. This improved accuracy not only reduces annoyance to the building occupants when the system makes a mistake and misclassifies an occupied work space or zone as unoccupied when it is actually occupied, but also may allow shortening of the time period for collecting network statistics. More specifically, while an HMM by itself may require a specific time period to achieve a desired level of accuracy, the use of additional factors in the classifier allow that time period to be reduced while still obtaining the same or an improved accuracy.

By adding other features 62 in data regarding time of day, day of the week, and similar factors, which do not require individual occupancy statistics, the method may have improved accuracy. These other features 62 may act as an error check or improve the output of the method in determining the status of the work spaces. More specifically, a building operator could vary the baseline activity needed to have a change in status of a work place, depending on what time of the day it is. For example, if one work space becomes occupied in a zone in the morning, the baseline at that time may be lower so that occupancy status from the model closely matches actual occupancy status. These extra modeling steps are especially helpful when a number of work spaces are clustered into zones.

In the first stage of the two stage approach 70 illustrated in FIG. 7, the network statistics data is modeled using an HMM 50 with k underlying states for the hidden variable, where the value of k is chosen to optimize the log-likelihood function, similar to the method in FIG. 6. In the second stage, a classifier 70 is trained, with the input being a feature vector 64 including the output state of k-HMM along with other external parameters such as time of the day and day of the week. Using time of day, day of the week, season, day of the month or other readily available data that is not associated with a particular work space allows the method to be implemented easily and cost effectively. The method remains tractable even on large datasets while efficiently incorporating the effect of any external parameters on the occupancy.

Advantages to adding the semi-supervised classifier 60 to the HMM 50 is that it significantly reduces the labeling effort of an occupant as compared to other supervised methods. The HMM allows a building manager to provide binary labels to the k output states of the HMM, rather than providing their occupancy logs over time. This also addresses the issue of privacy to some extent. The other advantage of using the k-HMM is that it significantly reduces the size of the input feature space, as k is usually very small compared to the total number of possible states for the network data. This semi-supervised approach 70 requires far less data than a supervised approach. In view of the close modeling of the occupancy in FIG. 9, using an unsupervised approach, the external features used in the semi-supervised approach are expected to be readily obtainable, and not to be individual network port labels.

One result of the HMM 50 as a first block in a semi-supervised approach 70 is that it results in a smaller feature space because it requires less training data to efficiently train a classifier 60. Any machine learning classifier can be used. Some examples are: a Naive Bayes classifier, a decision tree, and a support vector machine (SVM) based classifier. A Naive Bayes classifier is a simple probabilistic classifier based on applying Bayes theorem with strong independence assumptions. This model assumes that the feature values are independent of each other given the class of the data sample. However, the features need not necessarily be independent. On the other hand, in a decision tree classifier, the classification rules are implemented in a tree fashion where the answer to a decision rule at each node in the tree decides the path along the tree. Finally, an SVM builds a classifier that maximizes the margin between the two classes corresponding to the two occupancy states. Both the decision trees and an SVM based classifier can take into consideration the dependencies between different features. However, in all these methods, one preferably takes steps to prevent over-fitting of the model to the training data.

An example of a method described above in detail as using the classifier would include the blocks of (1) collect port level network statistics, (2) in the first stage, determine parameters of a k-state HMM (this is exactly similar to the previous approach with the difference being that the number of hidden states in the HMM are k instead of two, (3) collect some labeled data regarding occupancy state of work spaces, (4) input the outputs of the k-state HMM and the labeled data to train a classifier such as a Naïve Bayes classifier, a decision tree, or an SVM classifier. Once the models are trained, given a sequence of network statistics data and other features, compute the HMM output, followed by using the HMM output and the other features as input to the classifier. The output of the classifier gives the predicted occupancy state.

We claim:

1. A method of determining occupancy of a building comprising:
monitoring at least one of individual network ports within the building;
collecting an activity status of the individual network ports within the building; and
inputting the activity status into a hidden Markov model to determine occupancy status of the building.

2. The method of claim 1 wherein said step of inputting the activity status into a hidden Markov model to determine occupancy status of the building further includes the step of calculating an output from the hidden Markov model and inputting the output into a classifier.

3. The method of claim 2 wherein the classifier includes a feature vector.

4. The method of claim 2 wherein the classifier is one of a Naïve Bayes classifier, a decision tree, and a support vector machine classifier.

5. The method of claim 3 further including inputting additional features into the classifier and wherein the external features include at least one variable selected from the group of time of day, day of week, current month, and day of year.

6. The method of claim 2 further including training the classifier.

7. A method of determining occupancy of a building comprising:
collecting port level network statistics;
inputting the port level network statistics into an expectation maximization algorithm;
learning the parameters of a hidden Markov model; and
using a decoding algorithm to determine the best sequence of hidden states of the hidden Markov model.

8. The method of claim 7 further including:
monitoring at least one of individual network ports within the building;
collecting an activity status of the individual network ports for a selected area within the building; and
inputting the activity status into a hidden Markov model to determine occupancy status of the building.

9. The method of claim 8 wherein said reselected area within inputting the activity status into a hidden Markov model to determine occupancy status of the building further includes reselected area within calculating an output from the hidden Markov model and inputting the output into a classifier.

10. The method of claim 9 wherein the classifier includes a feature vector.

11. The method of claim 10 further including inputting additional features into the classifier.

12. The method of claim 7 wherein the expectation algorithm is a Baum-Welsh algorithm.

13. The method of claim 7 wherein said decoding algorithm is Viterbi algorithm.

14. A method of determining building occupancy comprising:
monitoring a plurality of network ports within the building;
collecting activity levels of the plurality of network ports;
determining the parameters of a k-state hidden Markov model;
inputting activity levels into the k-state hidden Markov model to obtain an initial occupancy status;
inputting the initial occupancy status into a classifier; and
predicting the occupancy status with the output of the classifier.

15. The method of claim 14 wherein said determining the parameters of a k-state hidden Markov model includes steps of collecting actual labeled occupancy status associated with a particular network port, and training of the classifier.
